(19) United States
(12) Patent Application Publication
(10) Pub. No.: US 2024/0087865 A1
(43) Pub. Date: Mar. 14, 2024

(54) SYSTEM AND METHODS FOR SEGMENTED FLOW ANALYSIS

(71) Applicant: DH Technologies Development Pte. Ltd., Singapore (SG)

(72) Inventor: Gary J. Van Berkel, Concord (CA)

(21) Appl. No.: 18/254,625

(22) PCT Filed: Nov. 30, 2021
(86) PCT No.: PCT/IB2021/061142

§ 371 Date: May 26, 2023

Related U.S. Application Data
(60) Provisional application No. 63/119,279, filed on Nov. 30, 2020.

(51) Int. Cl. H01J 49/04

(52) U.S. Cl. CPC H01J 49/0431

(57) ABSTRACT

The disclosure provides systems and methods for segmented flow analysis. More particularly, the disclosure relates to introducing a liquid sample and a segmenting liquid into a transport capillary for segmented flow analysis, wherein the liquid sample and/or the segmenting liquid are dispensed into the transport capillary as discrete droplets.

### RELATED US APPLICATIONS

This application claims the benefit of priority from U.S. provisional application No. 63/119,279, filed on Nov. 30, 2020, the entire contents of which is hereby incorporated by reference herein.

### FIELD OF THE INVENTION

This invention relates to systems and methods for analysis utilizing segmented flows.

### BACKGROUND

Segmented flow analysis is a common microfluidic approach to control sample dispersion for analytical techniques such as mass spectrometry and high-performance liquid chromatography. During segmented flow analysis, a sample, typically mixed with a carrier liquid, is ejected/dispensed into a transport capillary carrying a continuous flow of segmenting liquid. The segmenting liquid, which is immiscible with the capture liquid, effectively prevents dispersion and dilution of the sample droplets traveling through the capillary.

Segmented flow loading is particularly challenging, and requires a large volume of segmenting liquid. The oily nature of most immiscible segmenting liquids, typically fluorinated hydrocarbons, can cause contamination of a downstream ionization source and mass spectrometer, particularly when above nL/min flow rates are used. Further, under certain conditions, sample dispersion and dilution can benefit downstream analysis by preventing or reducing sample matrix effects for mass spectrometry, HPLC, and other analytical techniques.

Described herein are novel systems and methods for segmented flow analysis that reduce segmenting liquid volume, and allow for controlled dispersion and dilution of ejected/dispensed sample.

### SUMMARY OF THE DISCLOSURE

The disclosure generally provides systems and methods of segmented flow analysis. In various aspects and embodiments, the systems and methods of segmented flow provided by the disclosure may be used in combination with any variety of analytical instruments and techniques that are commonly used to detect, characterize, identify, separate, and/or purify one or more molecules in a sample.

In one aspect, a system for segmented flow analysis of a sample can include (a) a transport capillary for receiving a sample, and a segmenting liquid; (b) a droplet dispenser for providing the sample and the segmenting liquid to the transport capillary, wherein the sample and the segmenting liquid are dispensed into the transport capillary as discrete droplets; and (c) a conduit fluidly connected to the transport capillary that provides a capture liquid to the transport capillary.

In some embodiments, a system is provided for loading sample into a segmented flow. The system may include: a transport capillary for receiving at least one liquid sample and a flow of segmenting liquid; a droplet dispenser for dispensing the at least one liquid sample into the segmenting liquid at an open end of the transport capillary; and a conduit fluidly connected to the transport capillary that provides the segmenting liquid to the open end.

In embodiments, the segmenting liquid is immiscible with the sample and the capture liquid (e.g., selection can be based on immiscibility arising from difference(s) in polarity, hydrophobicity, hydrophilicity, aqueous, organic, etc.). Exemplary segmenting liquids may include, for instance, hydrocarbons (e.g., alkanes and cycloalkanes such as, e.g., heptane, octane) and halogenated solvents (e.g., perfluorodecalin, Novec HFE 7500, Fluorinet 40 (FC-40), and perfluorooctanol (FC-72)). In some aspects, the capture liquid is methanol.

In some aspects, the droplet dispenser comprises an acoustic droplet dispenser, a gravity dispenser, an electrostatic dispenser, a piezoelectric dispenser, a mechanical drive, or a pneumatic dispenser.

In some embodiments, the system can further include an ionization source that ionizes the sample and capture liquid when expelled from the transport capillary and/or a mass spectrometer operative to conduct mass analysis on the resulting sample ions. In certain aspects, the transport capillary has a typical geometry and dimensions, and in some embodiments may comprise an internal diameter of about 250 μm.

In embodiments the volume of an ejected sample droplet may be about 1-10 nanoliters, tens of nanoliters, or hundreds of nanoliters. In some embodiments the volume of an ejected sample droplet may be in the range of picoliters. In some embodiments the volume of a sample droplet may be about 2.5 nL.

The present disclosure further provides a method for segmented flow analysis of a sample, wherein the method can include (a) ejecting a sample into a open end of a transport capillary; (b) ejecting a segmenting liquid into the open end transport capillary, wherein the sample and segmenting liquid are alternately ejected into the transport capillary; and (c) running a capture liquid through the transport capillary to carry the sample and the segmenting liquid toward a sample outlet of the transport capillary.

In some embodiments, a method is provided for segmented flow analysis of a sample. The method may include: supplying a segmenting liquid to an open end of a transport capillary; dispensing a first liquid sample into the segmenting liquid at the open end; and drawing the segmenting liquid and first liquid sample through the transport capillary for delivery to an analytical device.

In embodiments of the methods, the segmenting liquid is immiscible with the sample and capture liquid. In embodiments of the method, some exemplary segmenting liquids include perfluorodecalin, Novec HFE 7500, Fluorinet 40 (FC-40), and perfluorooctanol (FC-72). In some aspects of the method, the capture liquid is methanol.

In some embodiments, the dispensing may be performed by non-contact droplet loading using an acoustic droplet ejector (ADE). In some embodiments, the sample and segmenting liquid are each separately ejected as one or more discrete droplets.

In some embodiments, the methods may further comprise ejecting a plurality of different samples into the open end of the transport capillary and alternately ejecting segmenting liquid between each of the samples.

In some aspects, the methods further include ionizing the sample carried in the transport capillary, wherein the ionization method can be Electron Impact Ionization (EI), Fast Atom Bombardment (FAB), Electrospray Ionization (ESI), Atmosphere Pressure Chemical Ionization (APCI) or Matrix Assisted Laser Desorption Ionization (MALDI). In some further embodiments the method comprises ESI.

In some aspects, the methods further include performing mass spectrometry on the sample.

In some aspects, the methods further comprise contacting the interior of the transport capillary with a dynamic or a permanent surface coating comprising a wetting agent that increases the contact interaction between the capillary surface and the segmenting liquid. In embodiments comprising a fluorinated segmenting liquid, the surface coating may comprise a derivatizing agent such as, for example, trichloro(1H,1H,2H,2H-perfluoroocytyl)silane.

In some aspects, the methods further include adjusting the volume of the capture liquid to control dispersion and dilution of the sample traveling through the transport capillary.

### BRIEF DESCRIPTION OF THE DRAWINGS

FIG. 1 illustrates segmented flow analysis using a continuous flow of segmenting liquid.

FIG. 2 illustrates dispersion of a sample droplet traveling through a transport capillary.

FIG. 3 illustrates segmented flow analysis according to some aspects of the present disclosure.

FIGS. 4A and 4B compare the dispersion of sample droplets as a function of the distance between the sample droplets and the segmenting liquid droplets.

FIG. 5 illustrates a segmented flow system for mass spectrometry according to some aspects of the present disclosure.

FIGS. 6A and 6B illustrate segmented flow analysis of multiple samples according to some aspects of the present disclosure.

FIG. 7A illustrates a co-axial geometry for the sampling end of an OPI.

FIG. 7B illustrates a co-linear geometry for the sampling end of an OPI.

FIG. 7C illustrates an acute geometry for the sampling end of an OPI.

FIG. 7D illustrates a transverse geometry for the sampling end of an OPI.

FIGS. 8A-8B illustrate an open port interface (OPI) sampling interface and an acoustic droplet ejection (ADE) device in accordance with some example aspects and embodiments of the disclosure.

### DETAILED DESCRIPTION

Described herein are systems and methods of loading a sample and a liquid or solvent into an apparatus for Segmented Flow Analysis. “Segmented Flow Analysis”, “segmented flow delivery”, or “SFA” as used herein refers to the introduction of a sample into the transport tubing, capillary, or coil(s) of a first apparatus having a first function, wherein the sample is transported as discrete or disconnected segments and delivered to a second apparatus having a second function. The methods described herein can involve independent droplet ejection of a plurality of different liquid samples and a segmenting liquid, immiscible with the capture liquid of the liquid samples, into the continuous flow of a transport or capture liquid such that each liquid sample is separated by a droplet, or volume, of segmenting liquid. Each of the liquid samples may be ejected as one or more discrete droplets to make up a volume of liquid sample ejected into the capture liquid and separated by a volume of segmenting liquid from other liquid samples.

As discussed herein, a suitable segmenting liquid can be selected based on its immiscibility with the liquid sample and capture liquid. In some embodiments segmenting liquid selection can be based on immiscibility arising from difference(s) in polarity, hydrophobicity, hydrophilicity, aqueous component, organic component, etc. between the segmenting liquid and/or the liquid sample, and capture liquid. In embodiments comprising polar (i.e., aqueous) liquid sample and a capture liquid that is miscible with the liquid sample, exemplary segmenting liquids can include hydrocarbons (e.g., alkanes and cycloalkanes such as, e.g., heptane, octane) and halogenated solvents (e.g., perfluorodecalin, Novec HFE 7500, Fluorinet 40 (FC-40), and perfluorooctanol (FC-72)). In some aspects, the capture liquid may comprise lower alcohols (e.g., C1-C3 alcohols such as methanol or ethanol).

In some further embodiments the segmenting liquid may be selected based on its compatibility with any analytical device(s) that are coupled with the segmented flow systems disclosed herein. For example, in such embodiments the selected analytical device/technique may be “blind” to one or more available segmenting liquid(s), and the segmenting liquid may be selected based on its ability to generate little to no signal when delivered to an analytical instrument for analysis (e.g., the segmenting liquid is selected to have little to no absorbance within a given wavelength, does not ionize/ions are not detectable, etc.).

Any variety of transport tubing, capillaries, or coils may be used in accordance with aspects and embodiments of the disclosure. In some embodiments, the tubing, capillary, or coil may be selected based on the scale, application(s), and/or techniques that are incorporated or combined with the methods and systems disclosed herein. Some embodiments comprise a capillary (i.e., “transport capillary”) comprising dimensions and materials that are generally known and available to one of skill in the art. In some embodiments a capillary comprises an internal diameter of from about 50 μm to about 500 μm (e.g., about 60, 70, 80, 90, 100, 125, 150, 175, 200, 225, 250, 275, 300, 325, 350, 375, 400, 425, 450, 475, or about 500 μm), or from about 50-250 μm, or from about 100-250 μm.

In some embodiments the capillary material comprises stainless steel, glass, fused silica, or a polymer (e.g., plastics, PEEK, etc.) as known in the art. In accordance with various aspects and embodiments of the disclosure, adequate contact and interaction between the segmenting liquid and the inner wall of the transport capillary (e.g., wettability) can help ensure that adequate segmented flow is achieved. In some embodiments, the systems and methods can comprise contacting the interior of the transport capillary with a dynamic or a permanent surface coating comprising a wetting agent that increases the contact interaction between the capillary surface and the segmenting liquid. Any suitable wetting agent or derivatizing agent may be used in accordance with such embodiments, and may be selected based on the capillary, tubing, or coil material and any existing surface modification it may comprise, and/or the segmenting liquid (e.g., a fluorinated segmenting liquid). In some embodiments that comprise a fluorinated segmenting liquid, the surface coating may comprise a derivatizing agent that enhances wettability between the interior surface and the fluorinated segmenting liquid such as, for example, trichloro(1H,1H,2H,2H-perfluoroocytyl)silane.

Methods, equipment, and means for droplet ejection or delivery (i.e., via a droplet dispenser) of a sample and/or segmenting liquid to a transport capillary can include a variety of droplet dispensers including, for instance, acoustic droplet ejectors (i.e. ADE) or dispensers, gravity dispensers, electrostatic dispensers, piezoelectric dispensers, mechanical drive dispensers, and pneumatic dispensers etc. In some embodiments, gravity dispensers can be used to dispense larger sample volumes (e.g. ≥1 μL). In other embodiments, electrostatic, piezoelectric, mechanical drive, or pneumatic dispensers can be used to dispense smaller sample volumes (e.g. ≥1 nL, 1.0 nL-100 nL, etc.). Exemplary pneumatic dispensers include, for instance, Immediate Drop on Demand Technology (I-DOT; Dispendix).

In accordance with the aspects and embodiments described herein, the droplet dispenser and the transport capillary may comprise any suitable arrangement and orientation that allows for the delivery of the liquid sample droplet and/or the segmenting liquid to the transport capillary. In some embodiments, the droplet dispenser may be oriented opposite from the transport capillary (e.g., an open end of the transport capillary), at an approximate 180 degree angle (i.e., above or below, left or right, etc.). In some embodiments, the droplet dispenser and the transport capillary may be arranged in an orientation that is generally adjacent to each other (e.g., at an angle ranging from about 20-160 degrees). In yet other embodiments, the droplet dispenser and the transport capillary may be in direct fluid communication via, for example and integrated connection from the dispenser to the transport capillary.

In accordance with some aspects and embodiments, the systems and methods can comprise an acoustic droplet dispenser that dispenses liquid sample from a sample source, such as a microtiter plate, and delivers the liquid sample for SFA. In such embodiments, and other embodiments that provide a non-contact droplet delivery of liquid sample, the methods and systems are operative using low sample volumes, and eliminate the need for high-pressure pumps and ejector valves. The embodiments further reduce the potential for liquid sample carryover and contamination between samples, and can separate the dispensing and delivery from any subsequent and analytical processes. As used herein, “non-contact droplet loading” or “non-contact sample delivery” refers to direct delivery of a liquid sample from a sample source to a transport capillary without use of an intermediate device that contacts the sample, such as a pipette, tubing, or ejector pump. Exemplary droplet generators include the piezoelectric PolyPico dispensing head (PolyPico Technologies Ltd.), which dispenses low sample volumes (20-120 pL) and the Labcyte Echo® which can acoustically dispense droplets in volumes on the order of nL. In some particular embodiments, the methods and systems can comprise the Sciex Echo® MS system, which is operative to dispense droplets in the range of nL directly into an open port interface (OPI) and capture liquid flowing from 100-1000 μL/min. The OPI and transport capillary can deliver a segmented flow comprising a liquid sample and segmenting liquid to a conventional electrospray ion source for mass analysis.

In another aspect, the disclosure relates to segmented flow delivery of a liquid sample to other types of secondary devices and systems for chemical analysis, such as liquid chromatographic systems (e.g., high performance liquid chromatography (HPLC)), electrophoresis, GC-MS, ICP-MS, UV-Vis or other analytical systems and techniques.

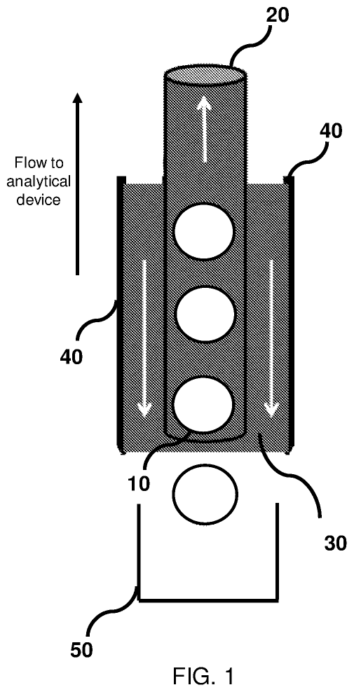

SFA can be used to prevent or reduce the spreading or dispersion and dilution of an eject sample as it travels through a capillary. As illustrated in FIG. 1, in an embodiment, sample droplets 10 are ejected from a sample well 50 into a capture region of an open end of a transport capillary 20 fluidly connected to a continuous flow of segmenting liquid 30 housed in a supply conduit 40. The segmenting liquid 30, which is immiscible with the solvent or liquid carrier of the sample droplets 10, prevents dispersion and dilution as the droplets travel through the capillary. Such a configuration is advantageous for preserving sample concentration, promoting tight sample stacking in transfer capillaries of analytical devices, and for analytical devices utilizing sub-nL/min flow rates.

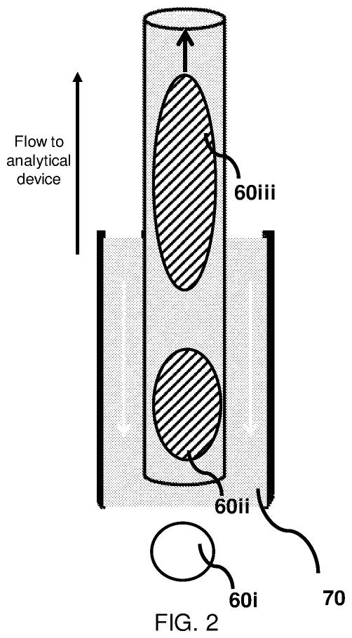

However, under certain conditions, sample dispersion and dilution (FIG. 2 illustrates dispersion of sample droplet 60 in capture liquid 70) can benefit downstream analysis, and the configuration of FIG. 1 is not ideal. For example, sample dispersion and dilution can be used to prevent, eliminate, or reduce sample matrix effects for mass spectrometry, HPLC, and other analytical techniques and avoid sample preparation bottlenecks. As used herein, “sample matrix effect” refers to the direct or indirect alteration or interference in a target sample response due to the presence of unintended or contaminating analytes or other interfering substances in the target sample. Further, depending on the geometry of the capillary, segmented flow without dispersion results in a flow rate that is too fast for downstream analysis (e.g. samples elute too quickly for mass spectrometry detection).

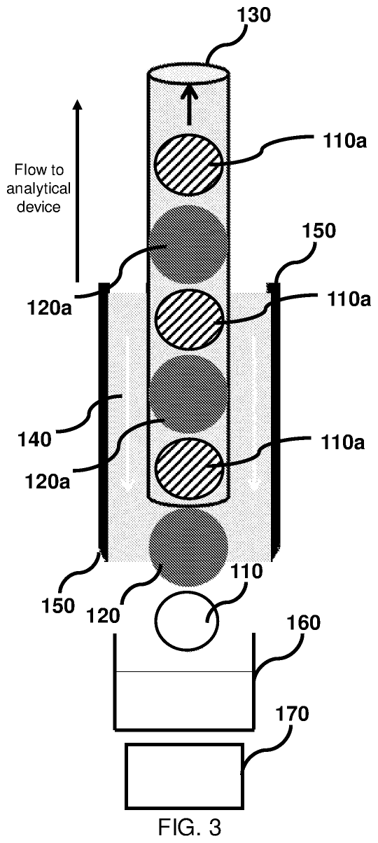

The systems and methods disclosed herein can be used to control, modulate, or manipulate the dispersion and dilution of captured sample. An advantage of controlled dispersion and dilution is eliminating or reducing sample matrix effects. In an alternate SFA embodiment, as illustrated in FIG. 3, the system may be operative to selectively eject the sample droplets 110 and the droplets of segmenting liquid 120 into a capillary 130 fluidly connected to a capture liquid 140 housed in a supply conduit 150. Droplet ejection or non-contact droplet loading from sample well(s) 160 can be achieved by a droplet ejection device 170 such as an acoustic droplet dispenser. The sample droplets 110 and the droplets of segmenting liquid 120 are ejected into a capture region at the open end of the transport capillary such that each sample droplet ejection is separated by a droplet of segmenting liquid. The result is a sequence of sample droplet dilutions 110a or “plugs” in the transport capillary 130 each physically separated from one another by a segmenting liquid plug 120a. The segmenting liquid plugs 120a are no longer in the form of a droplet within the transport capillary 130, but generally defining barrier between each sample droplet dilution plug 110a. Suitable segmenting liquids 120 of the present disclosure are immiscible with the solvent or liquid carrier (e.g. water) of the sample droplets 110 and include, but are not limited to, fluorinated segmenting liquids such as perfluorodecalin, Novec HFE 7500, Fluorinet 40 (FC-40), and perfluorooctanol (FC-72). Segmenting liquid 120 is similarly immiscible with the capture liquid 140 (e.g. methanol). In some embodiments, the flow rate of methanol is about 300 μL/min.

In addition to controlled dispersion and dilution, the segmented flow of FIG. 3 is advantageous over the segmented flow of FIG. 1 as it reduces the volume of segmenting liquid delivered to the downstream ionization source. Depending on the properties of the segmenting liquid, large volumes can cause contamination of the downstream ionization source and mass spectrometer, particularly at higher (e.g. greater than nanospray) flow rates. The system illustrated in FIG. 3 can avoid, or at least minimize, downstream contamination via reduced segmenting liquid volume.

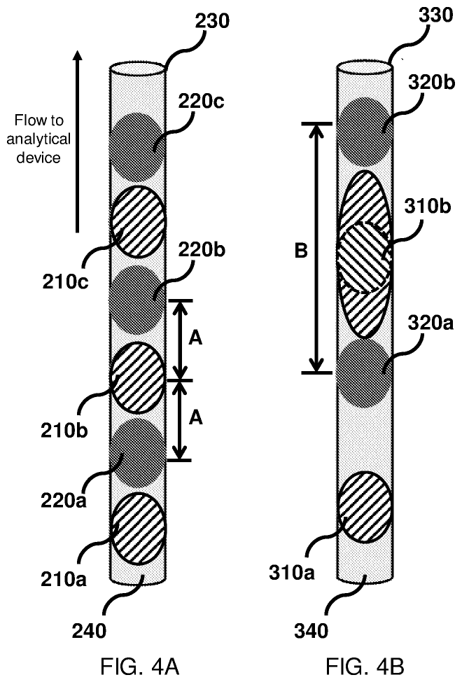

FIGS. 4A and 4B illustrate that the dispersion volume and dilution of the sample droplet plugs is a function of distance between sample droplets and segmenting liquid droplets. As shown in FIG. 4A, tight segmented flow (i.e. sample droplet dilutions 210a-c and segmenting liquid droplets 220a-c are closer together in capillary 230) thereby preventing or reducing dispersion in the sample droplet dilutions as they travel with the capture liquid 240 through the transport capillary. Alternatively, as shown in FIG. 4B, loose segmented flow (i.e. sample droplet dilutions 310a,b and segmenting liquid droplets 320a,b are spaced further apart in capillary 330), which allows for controlled dispersion and dilution of the sample droplets traveling through capture liquid 340 before delivery to the ionization source. Liquid droplet dilution 310b, for instance, illustrates controlled sample dispersion (indicated by the extended perimeter bounded by the segmenting liquid droplets 320a,b) as it travels through capillary 330.

In some embodiments, the methods can be adapted to provide droplet sequences or patterns, e.g., sequences or patterns that comprise segmenting liquid droplets, liquid sample droplets, and/or capture fluid that can be detected. In such embodiments a sequence or pattern can be used to identify one or more features of the SFA being detected such as, for example, transitions between liquid sample droplets or mixtures of two or more liquid sample droplets, timing for droplet delivery to the capture liquid, adjustment for capture liquid flow rate, adjustment for liquid sample and/or segmenting fluid droplet size and/or pattern, and the like. The sequences or patterns can be identified by a detectable signal or the absence of a detectable signal, either of which would have a characteristic ‘signature’ pattern that allows for its specific identification. Such embodiments relating to this type of “bar coding” pattern recognition can allow for variations in experimental settings without the need to recalibrate the settings based on consumption of sample.

The volume of the segmenting liquid introduced between samples should be sufficient to span the internal diameter of a transfer capillary and maintain a contiguous boundary during transport to the ionization source. For example, a transfer capillary having an internal diameter of 250 μm requires a minimum segmenting liquid volume of about 8-10 nL to provide consistent segmenting between samples. As described herein, the segmenting liquid is delivered to the transport capillary (or tube, coil, etc.) in an amount effective to provide a complete separation between sample droplets and/or capture fluid across the entire diameter of the particular capillary. The interaction between the segmenting liquid and the interior surface of the capillary (or tube, coil, etc.) can be enhanced using the surface modification techniques disclosed herein and as may be known in the art.

To control or modulate the dispersion and dilution of an ejected sample, the volume of capture liquid between the segmenting droplets can be varied and manipulated. In general, where the capture liquid is a solvent, dispersion and dilution of sample may vary with type of solvent, velocity gradients or turbulence within the transfer capillary, distance of transfer, etc. In some embodiments, sample dispersion and dilution may be moderated by providing a less turbulent flow and reducing the transfer distance.

When samples and segmenting liquid are ejected from a microtiter plate, the spacing between sample droplet dilutions and delimiting segmenting liquid droplets can be defined by the rate at which the ejector or dispenser can travel between sample and segmenting liquid wells. In some embodiments, the time to dispense a sample droplet and a segmenting droplet from their respective wells can be on the order of microseconds or seconds, e.g., from about 1-1,000 or more ms. For purposes of illustration FIG. 4 depicts example in accordance with an embodiment of the disclosure that includes a dispensing time of about 300 ms (illustrated as “A” in FIG. 4A), making the segmenting time or estimated peak width between segmenting droplets (illustrated as “B” in FIG. 4B) 300 ms.

As discussed herein, the liquid sample droplet size can vary similarly to the segmenting liquid droplet size. A plurality of sample droplets or segmenting liquid droplets may be rapidly ejected to make up a larger volume captured in the capture liquid. In some example embodiments, the sample droplet volume is in the range of picoliters. In some example embodiments, the sample droplet volume is from about 1.0 nL to about 10.0 nL, and may vary depending on transport capillary size. In some embodiments the sample droplet may be about 2.5 nL with a resulting radius of about 168 μm in a transfer capillary having an internal diameter of 250 μm. In some embodiments liquid sample droplet dispersion may be controlled. For example, liquid sample droplet dispersion may increase as segmenting time increases, which may result in and be observed as sample dispersion between different regions of segmenting liquid.

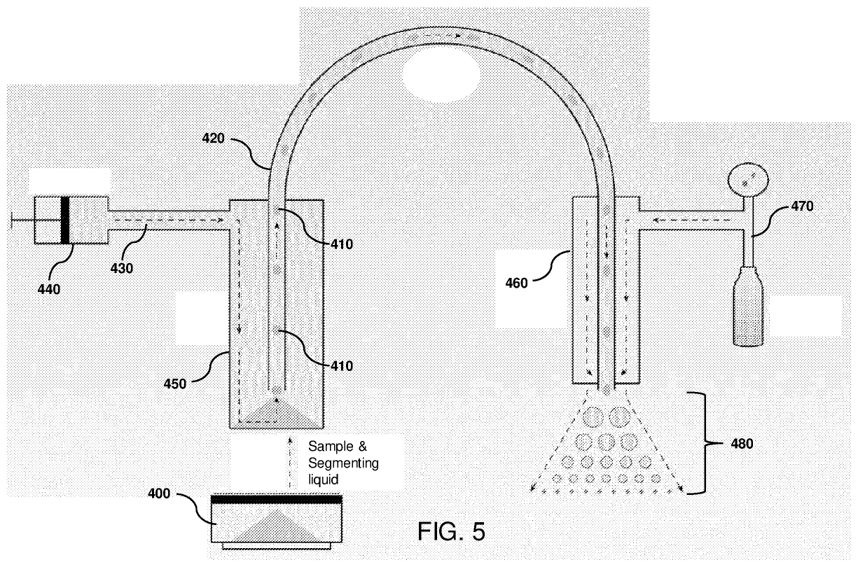

FIG. 5 illustrates an embodiment of a segmented flow system for mass spectrometry that includes an acoustic droplet dispenser 400 for non-contact droplet loading (NCDL) of sample droplets 410 and a segmenting liquid (droplets not shown) into a transport capillary 420. A capture liquid 430 is introduced via an ejector or pump 440 into a supply conduit 450. The capture liquid 430 transports sample droplets 410 and the segmenting liquid droplets into the capillary 420. Sample droplets 410 are subsequently delivered to an ionization zone 460 where an ionization source 470 produces an ionized vapor 480 that is delivered to a downstream mass spectrometer for analysis. While FIG. 5 depicts Electrospray Ionization (ESI) for sample ionization, it will be understood that other ionization methods are suitable for use with the systems described herein, and include Electron Impact Ionization (EI), Fast Atom Bombardment (FAB), Atmospheric Pressure Chemical Ionization (APCI), and Matrix Assisted Laser Desorption Ionization (MALDI).

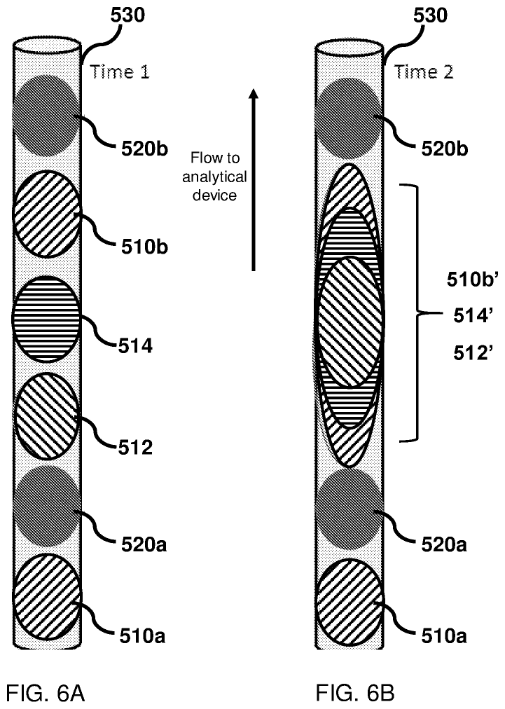

In another aspect, the systems and methods described herein can be used to eject more than one sample volume between segmenting liquid volumes. As illustrated in FIGS. 6A and 6B, sample volume dilutions 510 a,b, 512, and 514, each representing a unique sample identity, were sequentially ejected into capillary 530. The sample volume dilutions 510b, 512, and 514 are collectively disposed between the segmenting liquid volumes 520a,b (FIG. 6A). The sample volume dilutions may disperse, dilute, and mix as they travel through the capillary 530 (illustrated as the collective dispersion of diluted sample volumes 510b′, 514′, and 512′ in FIG. 6B). In some aspects, the sample droplet dilutions may comprise reactants which allows for on-line reactions during SFA. The segmenting liquid volume 520a,b delimiting a reaction space in which the sample volume dilutions 510b, 512, and 514 are isolated and may mix and react without intermingling with subsequent sample volume dilutions, such as sample volume dilution 510a. As the segmenting liquid volumes limit an extent of dispersion, flow rates and/or capillary length can be increased to increase reaction time if useful prior to delivery to the ionization source.

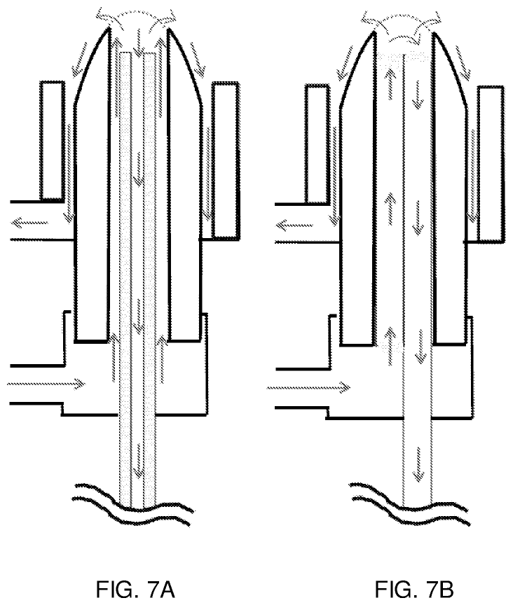

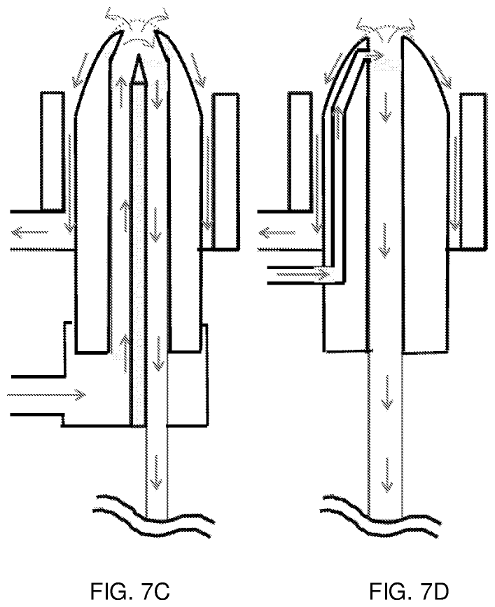

FIGS. 7A-7D illustrate different geometric configurations for the sampling end of an OPI. These embodiments also illustrate an alternative arrangement wherein the open end of the sampling probe is oriented to face up to receive ejected volumes/droplets delivered from above. As indicated above, the sampling probe can be oriented in a variety of directions, including the two examples provided in this description. In some preferred aspects, the systems and methods disclosed herein use the co-axial geometry (FIG. 7A) for sample loading.

In another aspect, the present disclosure relates to systems for delivering segmented flow of a sample to a secondary apparatus for chemical analysis, such as high performance liquid chromatography (HPLC), optical detectors, or mass spectrometry. In a particular aspect, the systems disclosed herein deliver a segmented sample to an ionization source for subsequent mass spectrometry. Such systems can be coupled with or integrated into the open port sample interface (OPSI, or OPI) as disclosed in U.S. Pat. No. 9,632,066, which is incorporated by reference herein in its entirety. In some embodiments, the OPI is a continuous flow, open interface for transferring samples into a capillary solvent stream for subsequent dilution and transfer to an ion source for ionization and subsequent mass spectrometric analysis. In some embodiments, the systems can be coupled to an Echo® MS (SCIEX) for Acoustic Ejection Mass Spectrometry. The Echo® MS uses an OPSI/OPI to capture low (e.g. nL) volumes of acoustically generated sample droplets from individual wells of a microtiter plate and transfers them to an ionization source for mass spectrometry. An exemplary AEMS system is described, for instance, in WO2019/104235, which is incorporated herein in its entirety.

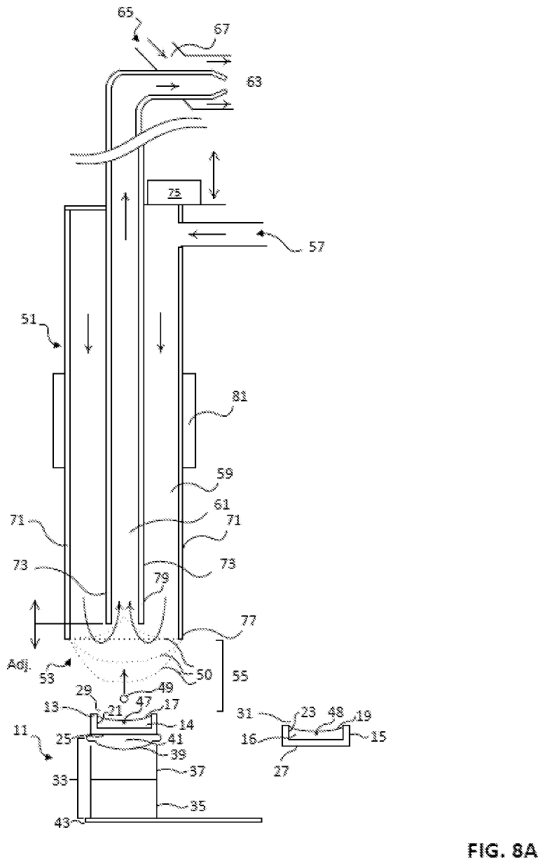

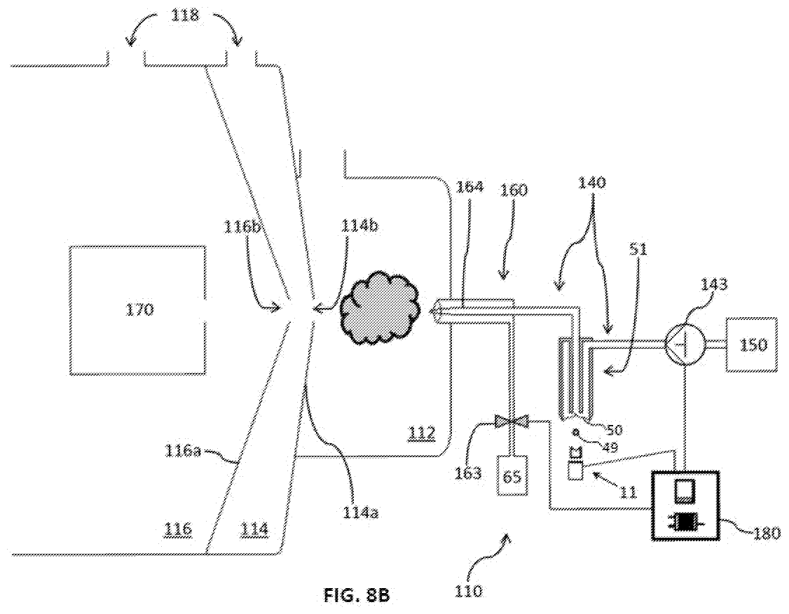

In accordance with the disclosure, a representative system that may be utilized in aspects and example embodiments of the disclosed methods and compositions is illustrated in FIG. 8A. As with all figures referenced herein, in which like parts are referenced by like numerals, FIG. 8A is not to scale, and certain dimensions are exaggerated for clarity of presentation. In FIG. 8A, the droplet dispenser is presented as an acoustic droplet dispenser, or acoustic droplet ejection (ADE) device, is shown generally at 11, ejecting droplet 49 toward the continuous flow sampling probe (which may also be referred to herein as an open port interface (OPI)) indicated generally at 51 and into the open end at the sampling tip 53 thereof. The sampling probe may be oriented in a variety of configurations, including to present the open end capture region facing down, as in FIGS. 1 to 6B, facing up, as in FIGS. 7A to 7D, facing to the side, or some combination of the above.

The acoustic droplet ejection device 11 includes at least one reservoir, with a first reservoir shown at 13 and an optional second reservoir 31. In some embodiments a further plurality of reservoirs may be provided. Each reservoir is configured to house a fluid sample having a fluid surface, e.g., a first fluid sample 14 and a second fluid sample 16 having fluid surfaces respectively indicated at 17 and 19. When more than one reservoir is used, as illustrated in FIG. 8A, the reservoirs are preferably both substantially identical and substantially acoustically indistinguishable, although identical construction is not a requirement.

The ADE comprises acoustic ejector 33, which includes acoustic radiation generator 35 and focusing element 37 for focusing the acoustic radiation generated at a focal point 47 within the fluid sample, near the fluid surface. As shown in FIG. 8A, the focusing element 37 may comprise a single solid piece having a concave surface 39 for focusing the acoustic radiation, but the focusing element 37 may be constructed in other ways as discussed below. The acoustic ejector 33 is thus adapted to generate and focus acoustic radiation so as to eject a droplet of fluid from each of the fluid surfaces 17 and 19 when acoustically coupled to reservoirs 13 and 15, and thus to fluids 14 and 16, respectively. The acoustic radiation generator 35 and the focusing element 37 may function as a single unit controlled by a single controller, or they may be independently controlled, depending on the desired performance of the device.

The acoustic droplet ejector 33 may be in either direct contact or indirect contact with the external surface of each reservoir. With direct contact, in order to acoustically couple the ejector to a reservoir, it is preferred that the direct contact be wholly conformal to ensure efficient acoustic energy transfer. That is, the ejector and the reservoir should have corresponding surfaces adapted for mating contact. Thus, if acoustic coupling is achieved between the ejector and reservoir through the focusing means, it is desirable for the reservoir to have an outside surface that corresponds to the surface profile of the focusing means. Without conformal contact, efficiency and accuracy of acoustic energy transfer may be compromised. In addition, since many focusing means have a curved surface, the direct contact approach may necessitate the use of reservoirs that have a specially formed inverse surface.

Optimally, acoustic coupling is achieved between the ejector and each of the reservoirs through indirect contact, as illustrated in FIG. 8A. In the figure, an acoustic coupling medium 41 is placed between the ejector 33 and the base 25 of reservoir 13, with the ejector and reservoir located at a predetermined distance from each other. The acoustic coupling medium may be an acoustic coupling fluid, preferably an acoustically homogeneous material in conformal contact with both the acoustic focusing means 37 and the underside of the reservoir. In addition, it is important to ensure that the fluid medium is substantially free of material having different acoustic properties than the fluid medium itself. As shown, the first reservoir 13 is acoustically coupled to the acoustic focusing means 37 such that an acoustic wave generated by the acoustic radiation generator is directed by the focusing means 37 into the acoustic coupling medium 41, which then transmits the acoustic radiation into the reservoir 13.

In operation, reservoir 13 and optional reservoir 15 of the device are filled with first and second fluid samples 14 and 16, respectively, as shown in FIG. 8A. The acoustic ejector 33 is positioned just below reservoir 13, with acoustic coupling between the ejector and the reservoir provided by means of acoustic coupling medium 41. Initially, the acoustic ejector is positioned directly below sampling tip 53 of OPI 51, such that the sampling tip faces the surface 17 of the fluid sample 14 in the reservoir 13. Once the ejector 33 and reservoir 13 are in proper alignment below sampling tip 53, the acoustic radiation generator 35 is activated to produce acoustic radiation that is directed by the focusing means 37 to a focal point 47 near the fluid surface 17 of the first reservoir. As a result, droplet 49 is ejected from the fluid surface 17 into a capture region, toward and into the liquid boundary 50 at the open end of sampling tip 53 of the OPI 51, where it combines with capture liquid in the flow probe 53. In some embodiments, the capture liquid may be a solvent for combining with captured sample to create an analyte-solvent dilution that may be delivered to an analytical device. The profile of the liquid boundary 50 at the sampling tip 53 may vary from extending beyond the sampling tip 53 to projecting inward into the OPI 51 depending upon relative aspiration of fluid from the open end as compared to a supply of capture fluid to the open end. In a multiple-reservoir system, the reservoir unit (not shown), e.g., a multi-well plate or tube rack, can then be repositioned relative to the acoustic ejector such that another reservoir is brought into alignment with the ejector and a droplet of the next fluid sample can be ejected. The capture liquid in the flow probe cycles through the probe continuously, minimizing or even eliminating “carryover” between droplet ejection events. Fluid samples 14 and 16 are samples of any fluid for which transfer to an analytical instrument is desired, where the term “fluid” is as defined earlier herein.

The structure of OPI 51 is also shown in FIG. 8A. As can be seen in the FIG. 8A, the sampling tip 53 of OPI 51 is spaced apart from the fluid surface 17 in the reservoir 13, with a gap 55 therebetween. The gap 55 may be an air gap, or a gap of an inert gas, or it may comprise some other gaseous material; there is no liquid bridge connecting the sampling tip 53 to the fluid 14 in the reservoir 13. The OPI 51 includes a capture liquid inlet 57 for receiving capture liquid from a capture liquid source and a capture liquid transport capillary 59 for transporting the capture liquid flow from the capture liquid inlet 57 to the sampling tip 53, where the ejected droplet 49 of analyte-containing fluid sample 14 combines with the capture liquid. In embodiments where the capture liquid comprises a solvent, an analyte-solvent dilution is created. A capture liquid pump (not shown) is operably connected to and in fluid communication with capture liquid inlet 57 in order to control the rate of capture liquid flow into the capture liquid transport capillary, and thus the rate of capture liquid flow within the capture liquid transport capillary 59 as well.

Fluid flow within the OPI 51 carries the sample, or analyte-solvent dilution, through a sample transport capillary 61 provided by inner capillary tube 73 toward sample outlet 63 the transport capillary 61 for subsequent transfer to an analytical instrument. A sampling pump (not shown) can be provided that is operably connected to and in fluid communication with the sample transport capillary 61, to control the output rate from outlet 63. In a preferred embodiment, a positive displacement pump is used as the capture liquid pump, e.g., a peristaltic pump, and, instead of a sampling pump, an aspirating nebulization system is used so that the sample or analyte-solvent dilution is drawn out of the sample outlet 63 by the Venturi effect caused by the flow of the nebulizing gas introduced from a nebulizing gas source 65 via gas inlet 67 (shown in simplified form in FIG. 8A, insofar as the features of aspirating nebulizers are well known in the art) as it flows over the outside of the sample outlet 63. The capture liquid is then drawn upward through the sample transport capillary 61 by the pressure drop generated as the nebulizing gas passes over the sample outlet 63 and combines with the fluid exiting the sample transport capillary 61. A gas pressure regulator is used to control the rate of gas flow into the system via gas inlet 67. In a preferred manner, the nebulizing gas flows over the outside of the sample transport capillary 61 at or near the sample outlet 63 in a sheath flow type manner which draws the capture liquid through the sample transport capillary 61 as it flows across the sample outlet 63 that causes aspiration at the sample outlet upon mixing with the nebulizer gas.

The capture liquid transport capillary 59 and sample transport capillary 61 are provided by outer capillary tube 71 and inner capillary tube 73 substantially co-axially disposed therein, where the inner capillary tube 73 defines the sample transport capillary, and the annular space between the inner capillary tube 73 and outer capillary tube 71 defines the capture liquid transport capillary 59.

The system can also include an adjuster 75 coupled to the outer capillary tube 71 and the inner capillary tube 73. The adjuster 75 can be adapted for moving the outer capillary tube tip 77 and the inner capillary tube tip 79 longitudinally relative to one another. The adjuster 75 can be any device capable of moving the outer capillary tube 71 relative to the inner capillary tube 73. Exemplary adjusters 75 can be motors including, but are not limited to, electric motors (e.g., AC motors, DC motors, electrostatic motors, servo motors, etc.), hydraulic motors, pneumatic motors, translational stages, and combinations thereof. As used herein, “longitudinally” refers to an axis that runs the length of the probe 51, and the inner and outer capillary tubes 73, 71 can be arranged coaxially around a longitudinal axis of the probe 51, as shown in FIG. 8.

Additionally, as illustrated in FIG. 8A, the OPI 51 may be generally affixed within an approximately cylindrical holder 81, for stability and ease of handling.

FIG. 8B schematically depicts an embodiment of an exemplary system 110 in accordance with various aspects of the disclosure for ionizing and mass analyzing analytes received within an open end of a OPI 51, the system 110 including an acoustic droplet ejection device 11 configured to eject a droplet 49, from a reservoir into the open end of the OPI 51. As shown in FIG. 8B, the exemplary system 110 generally includes a OPI 51 in fluid communication with a nebulizer-assisted ion source 160 for discharging a liquid containing one or more sample analytes (e.g., via electrospray electrode 164) into an ionization chamber 112, and a mass analyzer 170 in fluid communication with the ionization chamber 112 for downstream processing and/or detection of ions generated by the ion source 160. A fluid handling system 140 (e.g., including one or more pumps 143 and one or more conduits) provides for the flow of liquid from a capture liquid reservoir 150 to the OPI 51 and from the OPI 51 to the ion source 160. For example, as shown in FIG. 8B, the capture liquid reservoir 150 (e.g., containing a liquid, desorption solvent) can be fluidly coupled to the OPI 51 via a supply conduit through which the liquid can be delivered at a selected volumetric rate by the pump 143 (e.g., a reciprocating pump, a positive displacement pump such as a rotary, gear, plunger, piston, peristaltic, diaphragm pump, or other pump such as a gravity, impulse, pneumatic, electrokinetic, and centrifugal pump), all by way of non-limiting example. As discussed in detail below, flow of liquid into and out of the OPI 51 occurs within a sample space accessible at the open end such that one or more droplets can be introduced into the liquid boundary 50 at the sample tip 53 and subsequently delivered to the ion source 160. As shown, the system 110 includes an acoustic droplet ejection device 11 that is configured to generate acoustic energy that is applied to a liquid contained with a reservoir (as depicted in FIG. 8A) that causes one or more droplets 49 to be ejected from the reservoir into the open end of the OPI 51. A controller 180 can be operatively coupled to the acoustic droplet ejection device 11 and can be configured to operate any aspect of the acoustic droplet ejection device 11 (e.g., focusing means, acoustic radiation generator, automation means for positioning one or more reservoirs into alignment with the acoustic radiation generator, etc.) so as to eject droplets into the OPI 51 or otherwise discussed herein substantially continuously or for selected portions of an experimental protocol by way of non-limiting example.

As shown in FIG. 8B, the exemplary ion source 160 can include a source 65 of pressurized gas (e.g. nitrogen, air, or a noble gas) that supplies a high velocity nebulizing gas flow which surrounds the sample outlet of the electrospray electrode 164 and interacts with the fluid discharged therefrom to enhance the formation of the sample plume and the ion release within the plume for sampling by 114b and 116b, e.g., via the interaction of the high speed nebulizing flow and jet of liquid sample (e.g., analyte-solvent dilution). The nebulizer gas can be supplied at a variety of flow rates, for example, in a range from about 0.1 L/min to about 20 L/min, which can also be controlled under the influence of controller 180 (e.g., via opening and/or closing valve 163). In accordance with various aspects of the disclosure, it will be appreciated that the flow rate of the nebulizer gas can be adjusted (e.g., under the influence of controller 180) such that the flow rate of liquid within the OPI 51 can be adjusted based, for example, on suction/aspiration force generated by the interaction of the nebulizer gas and the analyte-solvent dilution as it is being discharged from the electrospray electrode 164 (e.g., due to the Venturi effect).

In the depicted embodiment, the ionization chamber 112 can be maintained at an atmospheric pressure, though in some embodiments, the ionization chamber 112 can be evacuated to a pressure lower than atmospheric pressure. The ionization chamber 112, within which the analyte can be ionized as the analyte-solvent dilution is discharged from the electrospray electrode 164, is separated from a gas curtain chamber 114 by a plate 114a having a curtain plate aperture 114b. As shown, a vacuum chamber 116, which houses the mass analyzer 170, is separated from the curtain chamber 114 by a plate 116a having a vacuum chamber sampling orifice 116b. The curtain chamber 114 and vacuum chamber 116 can be maintained at a selected pressure(s) (e.g., the same or different sub-atmospheric pressures, a pressure lower than the ionization chamber) by evacuation through one or more vacuum pump ports 118.

It will also be appreciated by a person skilled in the art, and in light of the guidance herein, that the mass analyzer 170 can have a variety of configurations. Generally, the mass analyzer 170 is configured to process (e.g., filter, sort, dissociate, detect, etc.) sample ions generated by the ion source 160. By way of non-limiting example, the mass analyzer 170 can be a triple quadrupole mass spectrometer, or any other mass analyzer known in the art and modified in accordance with the teachings herein. Other non-limiting, exemplary mass spectrometer systems that can be modified in accordance various aspects of the systems, devices, and methods disclosed herein can be found, for example, in an article entitled “Product ion scanning using a Q-q-Qₗᵢₙₑₐᵣ ion trap (Q TRAP®) mass spectrometer,” authored by James W. Hager and J. C. Yves Le Blanc and published in Rapid Communications in Mass Spectrometry (2003; 17: 1056-1064), and U.S. Pat. No. 7,923,681, entitled “Collision Cell for Mass Spectrometer,” which are hereby incorporated by reference in their entireties. Other configurations, including but not limited to those described herein and others known to those skilled in the art, can also be utilized in conjunction with the systems, devices, and methods disclosed herein. For instance other suitable mass spectrometers include single quadrupole, triple quadrupole, ToF, trap, and hybrid analyzers. It will further be appreciated that any number of additional elements can be included in the system 110 including, for example, an ion mobility spectrometer (e.g., a differential mobility spectrometer) that is disposed between the ionization chamber 112 and the mass analyzer 170 and is configured to separate ions based on their mobility through a drift gas in high- and low-fields rather than their mass-to-charge ratio). Additionally, it will be appreciated that the mass analyzer 170 can comprise a detector that can detect the ions which pass through the analyzer 170 and can, for example, supply a signal indicative of the number of ions per second that are detected.

### EXAMPLES

### Example 1

Table 1 compares the flow rate and elution time of 2.5 nL sample droplets ejected into capillaries having an internal diameter of 250 μm or 127 μm. Samples were ejected into a continuous (i.e. non-discrete) flow of segmenting liquid.

TABLE 1
Flow Rates of Sample Droplets Ejected into
Continuous Flow of Segmenting liquid

| Internal | | | Seg- | | | |
|---|---|---|---|---|---|---|
| Diameter of | Length | | menting | | Capil- | |
| Transfer | of | | liquid | | lary Exit | Sample |
| Capil- | Capil- | | Flow | Sample | Rate of | Elution |
| lary | lary | (μL/ | Rate | Volume | Solution | Time |
| (μm) | (cm) | cm) | (μL/min) | (nL) | (μL/s) | (ms) |
| 250 | 50 | 0.51 | 250 | 2.5 | 4.17 | 0.6 |
| 127 | 50 | 0.13 | 1 | 2.5 | 0.0167 | 150 |

### Example 2

Table 2 compares the dilution factor of various sample volumes ejected into a capillary having a 250 μm internal diameter. Values are based on a methanol flow rate of 250 μL/min, and a 600 ms spacing between segmenting droplets.

TABLE 2
Dilution Factor of Sample Droplets Based on Sample Volume

| Sample Volume (nL) | 1.0 | 2.5 | 10 | 25 |
|---|---|---|---|---|
| Dilution Factor | 2500 | 1000 | 250 | 100 |

The presently described technology is now described in such full, clear, concise, and exact terms as to enable any person skilled in the art to which it pertains, to practice the same. It is to be understood that the foregoing describes preferred aspects of the technology and that modifications may be made therein without departing from the spirit or scope of the invention as set forth in the appended claims.

1. A system for loading sample into a segmented flow, the system comprising
a) a transport capillary having an open end for receiving at least one liquid sample and a segmenting liquid;
b) a droplet dispenser for separately dispensing the at least one liquid sample and the segmenting liquid to the open end, wherein the at least one liquid sample and the segmenting liquid are alternately dispensed into the open end as discrete droplets; and
c) a conduit fluidly connected to the transport capillary that provides a capture liquid to the open end of the transport capillary.

2. The system of claim 1, wherein the segmenting liquid is immiscible with the at least one liquid sample and the capture liquid.

3. The system of claim 1, wherein the segmenting liquid is selected from the group consisting of perfluorodecalin, Novec HFE 7500, Fluorinet 40 (FC-40), and perfluorooctanol (FC-72).

4. The system of claim 1, wherein the droplet dispenser is selected from the group consisting of an acoustic droplet ejector, a gravity dispenser, a mechanical drive, an electrostatic dispenser, a piezoelectric dispenser, and a pneumatic dispenser.

5. The system of claim 1, wherein the droplet dispenser is an acoustic droplet ejector.

6. The system of claim 1, wherein the capture liquid is methanol.

7. The system of claim 1, further comprising:
an ionization source that ionizes the at least one liquid sample carried in the transport capillary.

8. The system of claim 1, further comprising:
a mass spectrometer.

9. (canceled)

10. (canceled)

11. The system of claim 1, wherein an open end of the transport capillary is oriented to face down, and wherein the droplet dispenser is operative to eject sample droplets up into the open end.

12. A method for segmented flow analysis of a sample, the method comprising:
a) dispensing a first liquid sample into an open end of a transport capillary;
b) dispensing a segmenting liquid into the open end of the transport capillary,
wherein the first liquid sample and the segmenting liquid are alternately dispensed into the open end as discrete droplets; and
c) running a capture liquid through the transport capillary to transport the first liquid sample and the segmenting liquid toward a sample outlet of the transport capillary.

13. The method of claim 12, wherein the segmenting liquid is immiscible with the first liquid sample and the capture liquid.

14. The method of claim 12, wherein the segmenting liquid is selected from the group consisting of perfluorodecalin, Novec HFE 7500, Fluorinet 40 (FC-40), and perfluorooctanol (FC-72).

15. The method of claim 12, wherein step a) comprises non-contact droplet loading of the first liquid sample and the segmenting liquid via an acoustic droplet ejector.

16. (canceled)

17. The method of claim 12, further comprising:
ionizing the first liquid sample carried in the transport capillary.

18. The method of claim 17, wherein the ionizing comprises an ionization method selected from the group consisting of Electron Impact Ionization (EI), Fast Atom Bombardment (FAB), Electrospray Ionization (ESI), Atmosphere Pressure Chemical Ionization (APCI), and Matrix Assisted Laser Desorption Ionization (MALDI).

19. The method of claim 12, further comprising:
performing mass spectrometry on the first liquid sample.

20. The method claim 12, further comprising:
treating the transport capillary with a dynamic or a permanent coating comprising a wetting agent on the interior surface of the transport capillary.

21. The method according to claim 20, wherein the coating comprises trichloro(1H,1H,2H,2H-perfluoroocytyl)silane.

22. The method of claim 12, further comprising:
adjusting the volume of the capture liquid to control dispersion and dilution of the first liquid sample traveling through the transport capillary.

23. (canceled)

24. (canceled)

25. (canceled)

26. (canceled)

27. A system for loading sample into a segmented flow, the system comprising
a) a transport capillary for receiving at least one liquid sample and a flow of segmenting liquid;
b) a droplet dispenser for dispensing the at least one liquid sample into the segmenting liquid at an open end of the transport capillary; and
c) a conduit fluidly connected to the transport capillary that provides the segmenting liquid to the open end.

28. (canceled)
